(19) United States
(12) Patent Application Publication
(10) Pub. No.: US 2005/0071856 A1
(43) Pub. Date: Mar. 31, 2005

(54) Dynamically loadable stub modules

(76) Inventors: C.P. Vijay Kumar, Santa Clara, CA (US); Sailu Yallapragada, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/670,265

(22) Filed: Sep. 26, 2003

(51) Int. Cl. G06F 9/46

(52) U.S. Cl. 719/330

(57) ABSTRACT

A dynamically loadable stub module, associated with a dynamically loadable kernel module (DLKM) includes a base stub module, means for defining DLKM data structures and wrapper functions, means for defining load and unload routines, means for defining metadata structures, means for allowing dynamic loading by DLKM infrastructures, and means for generating a dynamically loadable stub module object file.

### TECHNICAL FIELD

The technical field relates to processes and mechanisms used to configure UNIX® operating systems. More particularly, the technical field relates to dynamically loadable kernel modules.

### BACKGROUND

One central component of a computer system operating in a UNIX® environment is an operating system kernel. In a typical UNIX® environment, many applications, or processes, may be running. All these processes use the memory-resident kernel to provide system services. The kernel manages the set of processes that are running on the system by ensuring that each such process is provided with some central processor unit (CPU) cycles when needed, and by arranging for such process to be resident in memory so that the process can run when required. The kernel provides a standard set of services that allows the process to interact with the kernel. In the UNIX® environment, these services are sometimes referred to as system calls because the process calls a routine in the kernel to undertake some specific task. The kernel will then perform the task, and will return a result. In essence, the kernel fills in the gaps between what the process intends to happen and how system hardware needs to be controlled to achieve the process's objective.

The kernel's standard set of services is expressed in a set of kernel modules (or simply, modules). The kernel typically includes modules such as drivers, file system modules, scheduling classes, Streams modules, and system calls. These modules are compiled and subsequently linked together to form the kernel. When the system is started, or “booted up,” the kernel is loaded into memory.

In modular operating system kernels, a common practice is to create individual dynamically loadable kernel modules (DLKMs). Another common practice is to allow for on-demand loading of a kernel module when the kernel module is referenced or used for the first time. This process of loading a DLKM on demand is referred to herein as autoloading.

For modules that can be autoloaded, existing practice calls for providing a stub module that is always linked statically to the kernel. This stub module takes care of loading the actual DLKM on first reference or use. However, this practice has the disadvantage of requiring a rebuild of the kernel, and reboot of the system upon installation or removal of the DLKM, even when the kernel itself does not depend on the services provided by the DLKM.

### SUMMARY

What is disclosed is a dynamically loadable stub module, associated with a dynamically loadable kernel module (DLKM). The stub module includes a base stub module, means for defining DLKM data structures and wrapper functions, means for defining load and unload routines, means for defining metadata structures, means for allowing dynamic loading by DLKM infrastructures, and means for generating a dynamically loadable stub module object file.

Also disclosed is a method for dynamic loading of a stub module. The method begins by modifying a base stub module for an associated DLKM. The modification includes defining DLKM data structures and wrapper functions for the stub module, defining load and unload routines for the stub module, defining metadata structures for the stub module, providing for dynamic loading of the stub module by DLKM infrastructures, and generating a dynamically loadable stub module object file.

Finally, what is disclosed is a computer-readable medium having computer code to implement autoload stub modules. When executed, the code allows performance of the following steps: defining DLKM data structures and wrapper functions for the stub module, defining load and unload routines for the stub module, defining metadata structures for the stub module, providing for dynamic loading of the stub module by DLKM infrastructures, and generating a dynamically loadable stub module object file.

### DESCRIPTION OF THE DRAWINGS

The detailed description will refer to the following figures in which like numerals refer to like items, and in which:

FIG. 1 is a block diagram of a prior art computer system that uses dynamically loadable kernel modules;

FIGS. 2A and 2B are block diagrams of a computer system implementing an embodiment of a dynamically loadable stub module;

FIG. 3 is a block diagram of a computer system implementing another embodiment of a dynamically loadable stub module;

FIG. 4 is a flow chart illustrating a method for implementing an embodiment of dynamically loadable stub module;

FIGS. 5A-5C illustrate embodiments of dynamically loadable stub modules; and

FIG. 6 shows a computer system usable for developing a UNIX® operating system including dynamically loadable stub modules.

### DETAILED DESCRIPTION

A computer system operating in a UNIX® environment may have many applications, or processes, running. A memory-resident kernel manages the set of processes by ensuring that each such process is provided with some central processor unit (CPU) cycles when needed, and by arranging for each such process to be resident in memory so that the process can run when required. The kernel provides a standard set of services that allows the process to interact with the kernel. These services are sometimes referred to as system calls because the process calls a routine in the kernel to undertake some specific task. Code in the kernel will then perform the task for the process, and will return a result to the process.

The kernel's standard set of services is expressed in a set of kernel modules (or simply, modules). The kernel typically includes the following module types: file system, stream driver, streams, WSIO class driver, WSIO interface driver, and miscellaneous. These modules are compiled and subsequently linked together to form the kernel. When the system is started, or “booted up,” the kernel is loaded into memory.

To accommodate these modules, when the kernel is created, a number of module configuration tables may be generated and stored in a kernel memory. These configuration tables are grouped according to the type of modules to be loaded into the kernel. For example, the kernel may contain separate configuration tables for device drivers, streams modules, and file systems modules. The entries to the tables identifying the different modules need not be statically bound to the module name but may be made or allocated on an as-needed basis when the modules are installed into the kernel. Once a module is allocated an entry in the configuration table, the entry remains allocated until the system is rebooted.

To provide an accessible module in the kernel, the module is installed and loaded into the kernel. During the loading process, virtual and physical memory are reserved for the module. The module is written into physical memory, the module is relocated to its linked virtual address, and all symbol references are resolved. During installation, the module is connected into an appropriate configuration table such that an entry in the table for the module is allocated and filled in with the appropriate information. Alternatively, the module itself may contain the required configuration data.

The modules are compiled into an object code format prior to linking, such as the ELF format (Extensible Linker Format). The compiled modules are located in a predetermined portion of storage or other memory. Each module is identified by a name or handle, which is uniquely associated with the particular module, such as the name of the file system or system call.

Header information, referred to as a wrapper, is provided with each file to provide certain information regarding the file and the module. The wrapper identifies that the file is a loadable module, the type of module, and a pointer to the appropriate installation code for the type of module. The installation code in the kernel provides specific instructions as to the installation of the module in the appropriate configuration table. The wrapper is formed by inserting code into the source code of the module to generate the wrapper information.

Kernel modules can exist in different states; specifically, the modules can be in unused, static, loaded and auto states. Once a module has been installed on a system, the module can be brought into the kernel configuration using a kernel configuration command. An example of such a command is kcmodule. For example, kcmodule <modulename>=state will cause the module to change state to the requested state. More specifically, kcmodule <modulename>=static will bind the named module into the static kernel. Some state changes can require rebuilding the kernel configuration and rebooting the computer system. In particular, a kernel module that is statically bound to the kernel will, when installed, require rebuilding and rebooting. The kcmodule command provides the functionality to rebuild the static kernel when needed. The kcmodule command will also provide an appropriate message when a reboot is required to complete the change.

To overcome the limitation of rebuilding and rebooting, dynamically loadable kernel modules (DLKMs) have been developed. A DLKM can be loaded into a running kernel without the need for a kernel rebuild or system reboot. Most DLKMs are also unloadable, so that the DLKM can also be unloaded without requiring a rebuild or reboot.

A system administrator can select either of two module states that result in dynamic loading: loaded or auto. The difference between the two states is when dynamic loading occurs. In the loaded state, the DLKM is loaded immediately, and is loaded during each successive boot of the system. In the auto state, the DLKM is loaded when the services provided by the DLKM are needed. For example, if the DLKM is a driver, the system will load the DLKM when some process attempts to open the associated device special file. After each successive boot, the system will again wait until the DLKM is needed before loading the module.

In modular operating system kernels, a common practice is to allow for on-demand loading of a kernel module when the DLKM is referenced or used for the first time. Because DLKMs are not statically bound to the kernel, some mechanism must be in place to allow the DLKM to be loaded upon first use. For example, an exit( ) routine in the kernel may call shmexit( ) to clean up in case the exiting process was using shared memory. But if the shmexit( ) routine is now in a DLKM and thus is not linked with the resident part of the kernel, then the kernel would receive an undefined symbol. The solution is to provide a dummy routine for shmexit( ) linked with the resident part of the kernel. This routine knows how to load the appropriate module and transfer control to the target or “real” routine shmexit( ) in the DLKM. Such a resident dummy function is called a stub module. A stub module may be viewed as providing an indirect addressing function, much like a procedure linkage table entry, but with more flexibility. That is, the stub module provides an addressing function for a “real” module. For example, when control is transferred to a routine in the “real” module, the stack frames are arranged so it appears that the called routine of the stub module made the call directly to the “real” module routine. Thus, the caller's arguments are passed to the “real” routine. In another example, consider the case of a device drive embodied in a DLKM. The kernel maintains a switch table associating device special files, through their major numbers, to the device drivers. When a process opens the device special file, the kernel calls the device driver's open ( ) function through a function pointer in the switch table. If the device driver DLKM has not yet been loaded, the open ( ) function pointer in the switch table actually points to a stub module. The stub module causes the device driver DLKM to be loaded, and then the stub module replaces itself with the device driver's “real” open ( ) function.

DLKMs can be broadly classified into two categories: 1) modules accessed using switch tables in the kernel; and 2) modules accessed only by direct function calls. The first type of DLKM is accessed using indirect function calls, often through switch tables containing addresses of interface functions. Device drivers, Streams modules and drivers, and file systems belong to this first category of DLKMs. The kernel DLKM infrastructure defines generic stub modules for each module type. The stub modules are always statically linked to the kernel. When a DLKM is registered for autoloading, the address of the DLKM type is stored in the module's entry in the switch table. When the module is referenced for the first time, the stub module will load the corresponding module and transfer control to the actual routine. There is no need to rebuild the kernel when the DLKM is configured.

Any type of DLKM can have function calls that are accessed directly by interface function calls. Thus, the DLKM infrastructure cannot provide pre-defined, generic, statically linked stub modules for such DLKMs. Instead, the DLKM infrastructure provides a stub module mechanism that module developers can use to define their own stub modules.

Stub modules are supplied automatically for certain functions of wsio_class, wsio_intfc, streams_drv, streams_mod, and filesys DLKMs. Stub modules are not automatically supplied for miscellaneous (misc) types of DLKMs.

Stub modules may be classified as strong or weak. A strong stub module attempts to load a module if necessary and a weak stub module does not. In the example above, shmexit( ) is defined in the kernel as a weak stub module. Typically, a weak stub module is used for modules that indicate a resultant state simply by not being loaded in the kernel. For example, if the shared memory module is not already resident, there are no shared memory segments so there is no need to load the module just to find out that there are no shared segments.

For modules that can be dynamically loaded (i.e., DLKMs), existing practice calls for providing a stub module that is always linked statically to the core kernel. This stub module takes care of loading the actual DLKM on first reference or use. One advantage of this practice is that kernel memory is not consumed by modules that are not in use. Another advantage is that the most recent version of a module is available when that module is used. However, this practice has the disadvantage of requiring a rebuild of the kernel, and reboot of the system, upon installation or removal of the stub module, even when the kernel does not depend on the services provided by the DLKM. A DLKM can be autoloaded when the DLKM is first referenced, regardless of whether that reference is from the static kernel or some other DLKM.

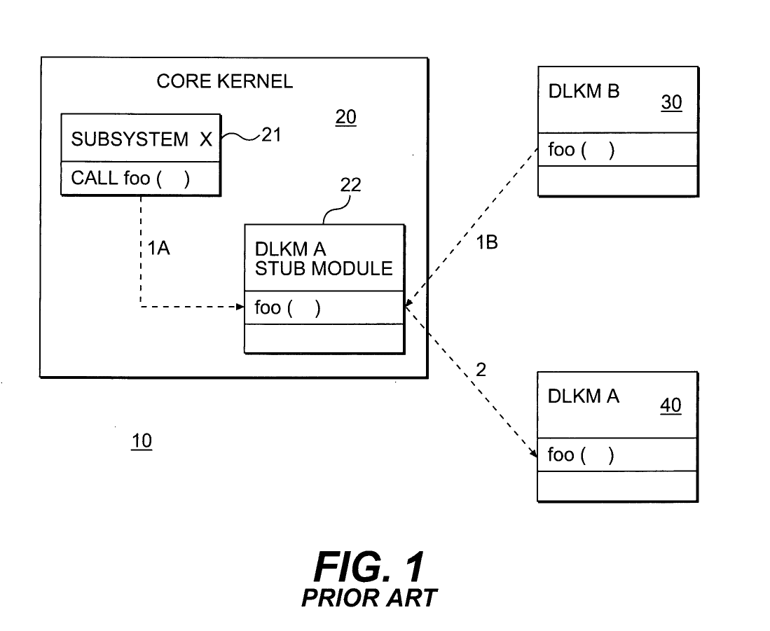

FIG. 1 illustrates a prior art mechanism for DLKMs. In FIG. 1, a computer system 10 includes a core kernel 20. The core kernel 20 includes subsystem×21, capable of making a kernel function call, and DLKM A stub module 22. DLKM B 30 and DLKM A 40 are available to provide services to the core kernel 20 or to provide services to each other.

In a first scenario, the services of DLKM A 40 are to be used by the core kernel 20. In a second scenario, the services of DLKM A 40 are used by the DLKM B 30. To install DLKM A 40, the DLKM A stub module 22 has to be linked to the core kernel 20. That is, either a kernel function call 1A or a kernel function call 1B results in process 2, dynamically loading the DLKM A 40 and transfer of control to function foo ( ). Hence, a rebuild of the core kernel 20 and a reboot of the computer system 10 is required for both the first and second scenarios.

To minimize kernel rebuilds, the prior art practice of statically linking stub modules to kernel is changed. In particular, the current DLKM stub module mechanism is changed to create a stub module that is itself a DLKM containing the necessary kernel metadata. This stub module will be referred to hereafter as an autoload stub module. The autoload stub module is capable of being statically linked to the kernel if required. Kernel modules that depend on the autoload stub module, list the autoload stub module in their list of dependencies.

To provide the required functionality, kernel modules may be separately compiled into a relocatable object. These modules are placed in storage until requested by the kernel. Configuration tables provided in the kernel memory are used to determine that either a module is located in the kernel or a module is not located in the kernel and therefore needs to be loaded into the kernel memory and linked with the modules already loaded in to the kernel memory. Subsystems within the kernel detect requests to access the configuration tables when a module is referenced, and intercept the request for access in order to determine whether or not the module is located in the memory. If the module is not in the kernel memory, procedures are executed to load the module into the kernel memory, dynamically link the module with the modules residing in the kernel memory, and install the module into the appropriate configuration table such that subsequent accesses will indicate that the module is loaded and installed in the kernel.

A module subsystem is provided in the kernel to intercept calls made to certain modules in the kernel, and to determine if the module is currently loaded in the kernel. The module subsystem intercepts each call to a module in order to determine whether or not the module has been loaded into the kernel memory and installed. The module subsystem will also intercept those calls from other modules which call modules in order to determine if the called modules have been loaded and installed. Other processes, such as user programs and libraries will issue system calls that are received in the kernel by the system call module. The module subsystem will determine if the particular call is supported by a module that has been installed in the kernel by examining a system call configuration table system. If the module has been loaded and installed, the operations corresponding thereto are performed.

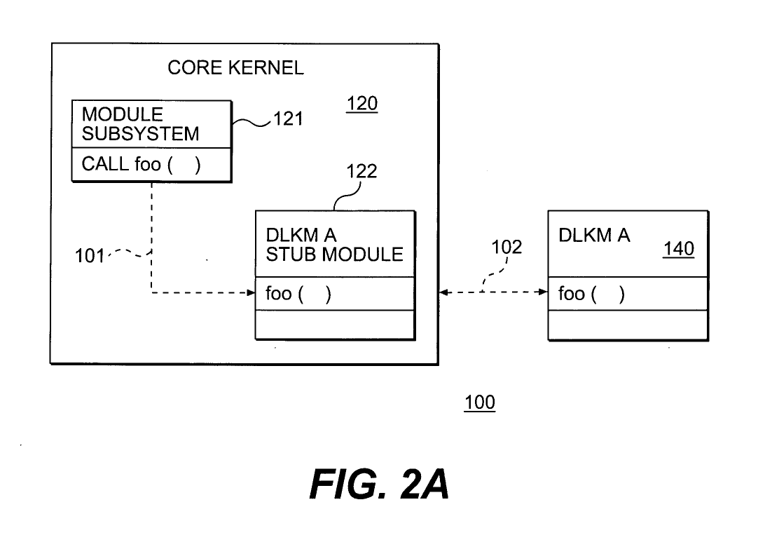

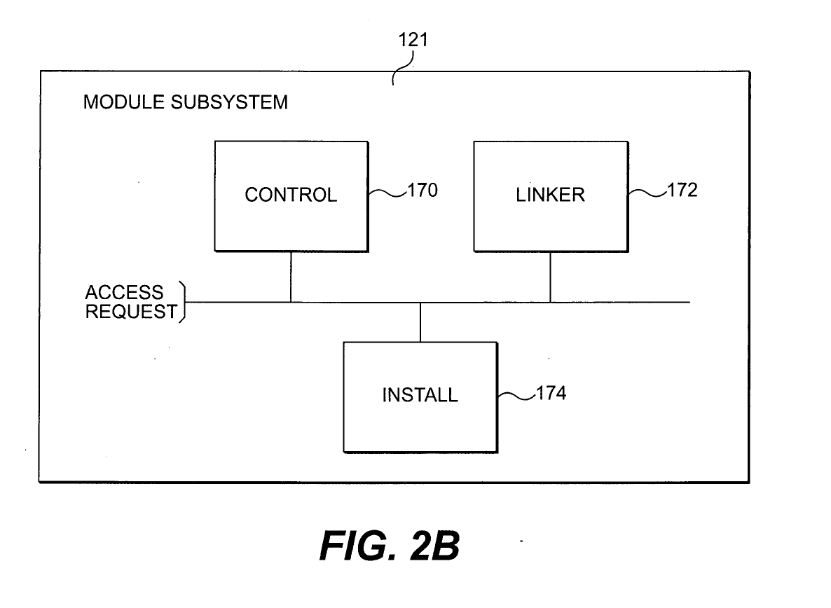

FIG. 2A illustrates a computer system 100 in which DLKMs are implemented. The computer system 100 includes core kernel 120. Included in the core kernel 120 is module subsystem 121 and DLKM A stub module 122. The computer system 100 includes DLKM A 140. When the core kernel 120 requires the services provided by DLKM A 140, the module subsystem 121 calls function foo ( ) 101. The DLKM A 140 then is dynamically loaded 102. However, the DLKM A stub module 122 is statically linked to the core kernel 120, requiring rebuild of the core kernel 120 and reboot of the computer system 100.

When the DLKM A stub module 122 is installed, there is a need to rebuild the kernel 120 and to reboot the system 100 to make the rebuilt kernel 120 take effect. Rebuilding the kernel configuration is invoked by the kconfig command. kconfig calls library functions to extract module metadata from module object files and libraries. kconfig also calls library functions to read and parse the system file. kconfig then constructs a kernel configuration in a directory that is an image of the computer system. At various predefined points in the boot process, kernel configuration code in the kernel is called, and the kernel registry and the embedded module metadata is searched to find actions that are supposed to occur at specific time. For example, the kernel registry can specify which modules should be loaded at particular dispatch points. The kernel configuration code also manages embedded data for other kernel subsystems.

Referring to FIG. 2B, the module subsystem 121 is shown in detail. The module subsystem 121 provides the DLKM infrastructure to implement dynamic loading. The module subsystem 121 includes control module 170, install module 174 and run-time linker 172. The control module 170 intercepts access requests for modules and examines the appropriate module configuration table to determine if the module already has been loaded. The install module 174 causes the module to be loaded when the control module 170 determines that a module does not exist in the kernel 120 and the run-time linker 172, resolves references between the modules already existing in the kernel 120 and the module to be loaded.

The module subsystem 121 determines the state of the module by reference to a corresponding module configuration table or by reference to metadata contained within the module. Modules are automatically loaded and installed when needed. Modules are needed when the functionality they provide is referred to by name (such as a push of a streams module or the mount of a filesystem) or when a module is needed to satisfy a kernel reference to a function not resident in the kernel. In an embodiment, these tables are located in the kernel memory referenced at a location identified by a particular symbolic or variable name that in turn identifies the type of module (e.g., fmodsw). For example, the configuration table for the file system modules is identified as “vfssw”. The names used and the table locations are preferably the same as those found in existing kernels.

The linker 172 fixes references in the code in the module to reference or call the correct address. Thus, the linker 172, using a name of a module to be called, will determine the address in the module where the function resides. This address is then written into the module at the function reference such that when the code is executed, the proper address is identified. Linker technology is well known to those skilled in the art and need not be described here.

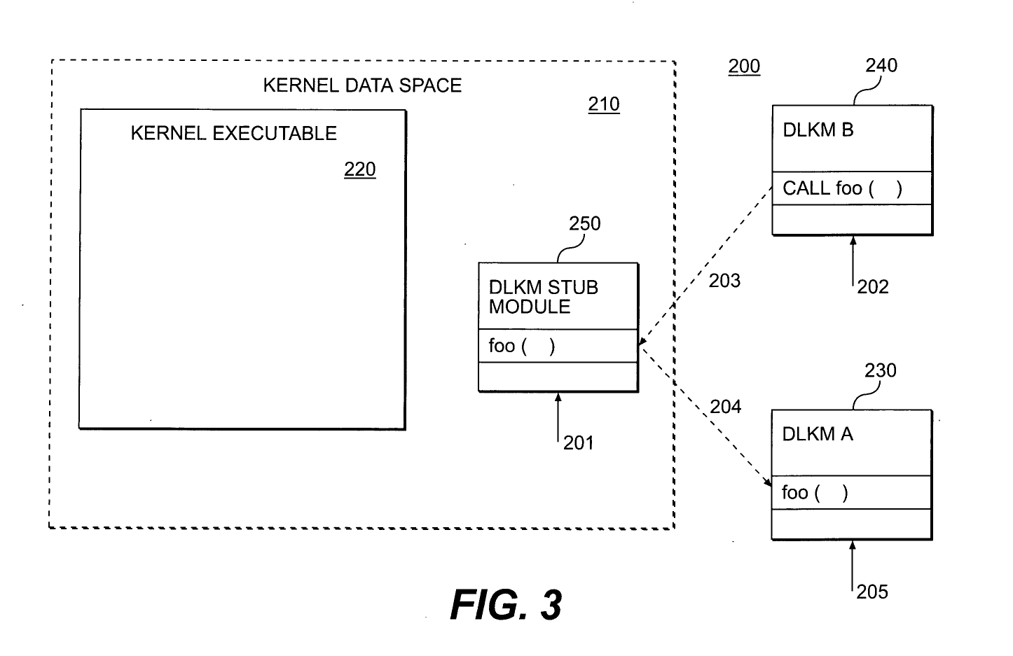

FIG. 3 illustrates another computer system 200 in which DLKMs and autoload stub modules are implemented. The computer system 200 includes kernel data space 210. The kernel data space 210 includes kernel executable 220 and DLKM stub module 250. Also included in the computer system 200 are DLKM A 230 and DLKM B 240. The DLKM A stub module 250 is associated with DLKM A 230.

The DLKM A stub module 250 is dynamically loaded 201 when DLKM A 230 is installed. The DLKM B 240 is dynamically loaded 202 when DLKM B 240 is installed. DLKM B 240 calls 203 function foo 0 to request the services of DLKM A 230. The call 203 is made to DLKM A stub module 250, which then demands 204 that DLKM A 230 be loaded. In response to the demand 204, the DLKM A 230 is dynamically loaded 205 and control is transferred to “real” function foo ( ) in the DLKM A 230. Because the services of DLKM A 230 are not used by the kernel data space 210, and the DLKM A stub module 250 is thus not statically liked to the kernel executable 220, the installation of DLKM A 230 does not result in rebuild of the kernel executable 220 or reboot of the computer system 200.

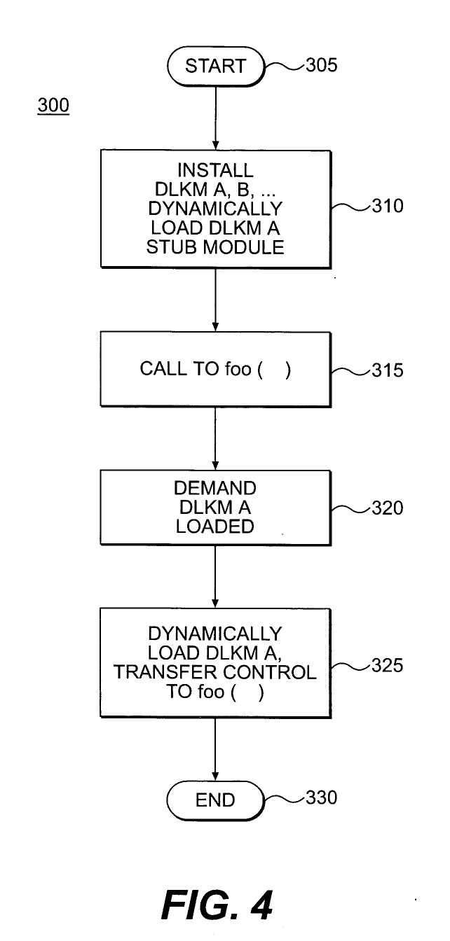

FIG. 4 is a flowchart illustrating operation of the computer system 200 including the features of autoload stub modules. A process 300 begins in block 305. The DLKM A stub module 250 is dynamically loaded (block 310) when DLKM A 230 is installed. In addition, the DLKM B 240 is dynamically loaded (block 310) when DLKM B 240 is installed. In block 315, DLKM B 240 calls foo ( ) to request the services of DLKM A 230. The call is made to DLKM A stub module 250. In block 320, the DLKM A stub module 250 demands 204 that DLKM A 230 be loaded. In response to the demand, the DLKM A 230 is dynamically loaded and control is transferred to “real” function foo ( ), block 325. The process 300 then ends, block 330. Because the services of DLKM A 230 are not used by the kernel data space 210, the installation of DLKM A 230 does not result in rebuild of the kernel executable 220 or reboot of the computer system 200.

For modules accessed through switch tables, generic autoload stub modules are already present in the kernel data space. For miscellaneous type DLKMs, however, the current DLKM infrastructure requires creation of stub modules (<module_name>_stub) using a stub development mechanism, and then a rebuilding of the kernel in order to install the DLKM. To eliminate rebuilding the kernel upon installation of the DLKM, the stub module for miscellaneous modules is converted to a DLKM (i.e., the autoload stub module). The autoload stub module would still be capable of static linking to the kernel. The DLKM and other modules that depend on the DLKM will list the autoload stub module in their list of dependencies. Following this approach, the kernel will not require rebuilding just to install the DLKM. However, if any of the core kernel modules depends on the DLKM for services, those core kernel modules will cite the autoload stub module as a dependency, causing the autoload stub module to be statically linked to the core kernel.

To make a stub module a DLKM (i.e., an autoload stub module), several alternatives are possible. In general, to make the stub module a DLKM, the following steps are completed:

The stub module's modmeta file is modified to indicate the stub module supports the loaded/auto states. The modmeta compiler reads the modmeta file and generates the kernel metadata structure for the module. Each DLKM contains metadata that describes the characteristics and capabilities of the DLKM. Modmeta data structures in the autoload stub module include the basic stub module metadata information structure such as kc_metadata_t. The kc_metadata_t structure may include: version, type, definition, states, and loadtime attributes, for example.

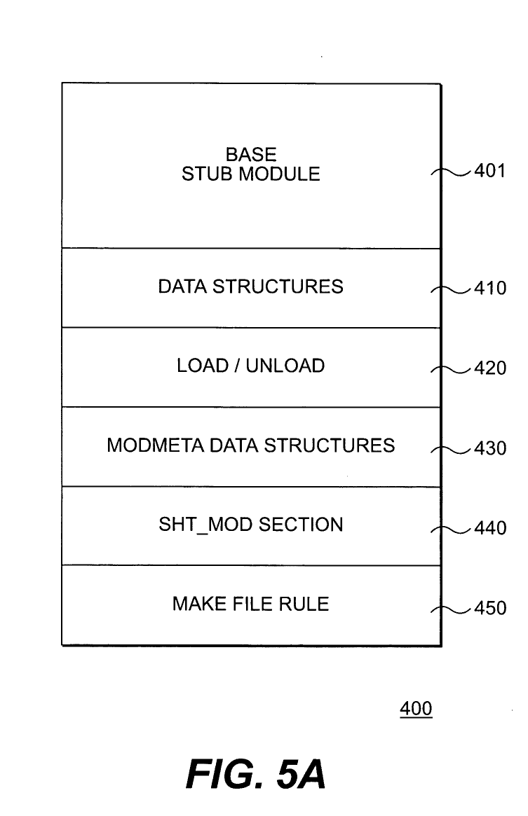

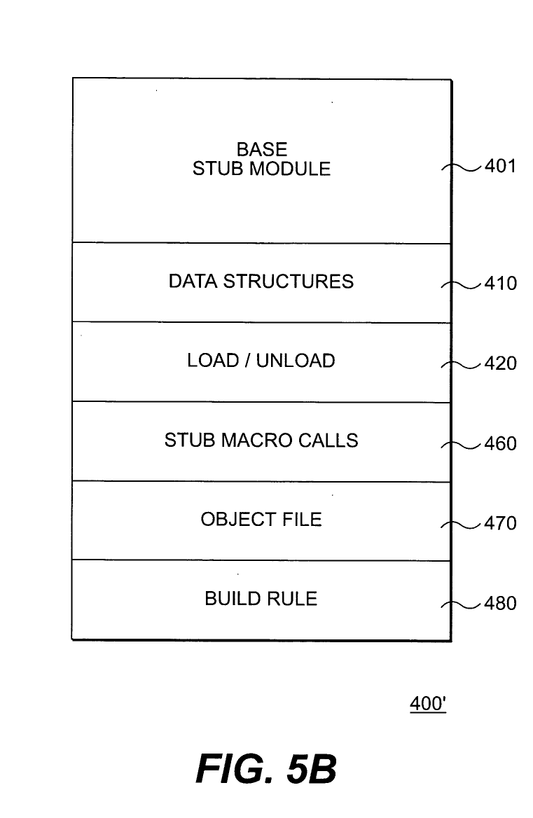

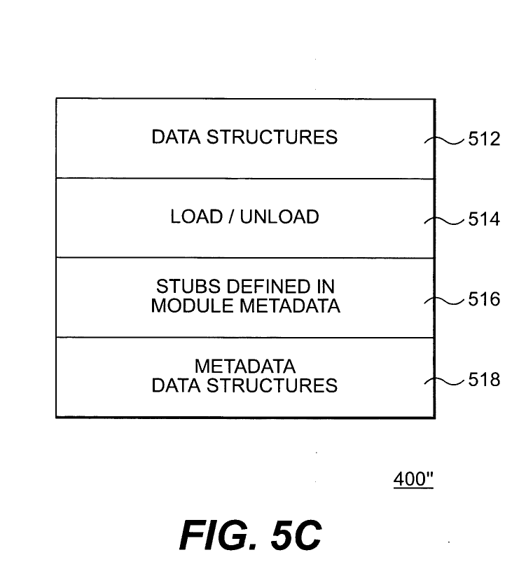

FIG. 5A shows the functionality that is added to a basic stub module 401 to make the basic stub module a DLKM 400 according to this embodiment. The basic stub module 401 is defined by a set of stub macros (e.g., stub.m4). These stub macros include:
MODULE ( ): Begin stub definition
STUB ( ): Define a strong, load-only stub
USTUB ( ): Define a strong, unloadable stub
WSTUB ( ): Define a weak, load-only stub
END ( ): End stub definitions

A macroprocessor tool (e.g., macroprocessor tool M4) reads the stub macros and generates the following:

A set of DLKM-related data structures 410 shown below:

extern struct mod_conf_data <module_name>_stub_conf_data;
static struct mod_type_data <module_name>_stub_drv_link = {
..
};
static struct modlink <module_name>_stub_mod_link[ ] = {
..
};
struct modwrapper <module_name>_stub_wrapper = {
..
};

These data structures 410 are used by the DLKM infrastructure to manipulate stack frames so that control is transferred to the appropriate DLKM function.
A pair of load/unload routines 420. The routines 420 are <module_name>_stub_load ( ) and <module_name>_stub_unload ( ).
Modmeta data structures 430, which include the basic stub module metadata information structure such as: version, type, definition, states, and loadtime attributes.
A SHT_MOD section 440, which is a special ELF section, is added to the basic stub module object file to allow dynamic loading by the DLKM infrastructures. The SHT_MOD section 440 contains the version number, maximum number of stubs, and address of struct modwrapper. The SHT_MOD section 440 is added by a tool called kmsecgen.
Revised makefile rule 450, which is a developer supplied <module_name>_stub_stub.mc file that is modified to generate a <module_name>stub_DLKM.

An alternative embodiment of an autoload stub module is illustrated in FIG. 5B. In this embodiment, the stub.m4 file is extended to provide only the necessary DLKM datastructures and wrapper functions. The remaining functions are provided by the DLKM developer. In FIG. 5B, an alternative autoload stub module 400′ begins with the basic stub module 401. The datastructures 410 and load/unload routines 420 are the same as described above, both of which can be added using the MODULE ( ) macro. A <module_name>_stub.mc file 460 contains calls to the stub macros. A <module_name>_stub.o object file 470 is generated from a developer-supplied file using a new makefile rule. For example, a developer-supplied <module_name>_stub_modmeta file is compiled by the modmeta compiler to produce a <module_name>_stub_modmeta.c file containing the module metadata structures. This C language file can be created using an existing ModMeta build rule. The file generally follows:

module <module_name>_stub {

| | |
|---|---|
| desc | “Autoload stub for the <module_name> DLKM” |
| type | misc |
| version | 0.1.0 |
| states | loaded static |
| loadable times | early_boot_load |
| unloadable | |
| } | |

A build rule 480 for MODULE produces the final <module_name>_stub DLKM after running kernel configuration tools (e.g., kmsecgen). The DLKM module associated with the autoload stub module 400′ specifies the module 400′ as a dependency.

The advantage of this second embodiment is that the autoload stub module 400′ makes use of existing kernel configuration tools without duplicating any functionality. The number of steps required to generate the module 400′ can be mitigated by using the metadata from the associated DLKM to automatically generate the metadata for the autoload stub module 400′. In addition, new makefile rules can be created to automate the process of running modmeta and kmsecgen.

A third embodiment of an autoload stub module 400″ is shown in FIG. 5C. The module 400″ abandons the stub.m4 stub macros altogether and instead takes advantage of the modmeta architecture to extend modmeta language to add a new section for autoload stub modules. Since every DLKM has a modmeta file, the modmeta files are used to define the autoload stub module 400″. The modmeta compiler is modified to accommodate the new data structures and to create an object file for the autoload stub module 400″.

A new definition, autoload, is used to define the stub module 400″. DLKMs may supply the stub information using an autoload statement. This language may be similar to that of the stub.m4 stub definition macros. The autoload statement includes the following:

| | |
|---|---|
| class | the class of stubs are unloadble or |
| | load only |
| stub funcname retfunc | a strong load-only stub |
| ustub funcname retfunc argnword | a strong unloadable stub |
| wstub funcname retfunc | a weak load-only stub |

funcname is the name of the “real” function (i.e., the DLKM function) and has the same name as in the autoload stub module 400″. retfunc is the name of the function to call on failure to load the DLKM. argnword is the number of arguments to be passed to the “real” routine.

The functionality provided by stub.m4 is transferred to the modmeta compiler. From the modmeta file, the modmeta compiler provides two files, one for the DLKM and one for the autoload stub module 400″. As shown in FIG. 5C, autoload stub module 400″ contains DLKM datastructures 512, DLKM load/unload routines 514, the stubs 516, and stub module metadata structures 518. The stubs 516 are the stubs defined in the module metadata. The other features of the autoload stub module 400″ shown in FIG. 5C are similar in structure, and perform similar functions as the corresponding features in the autoload stub module 400 of FIG. 5A.

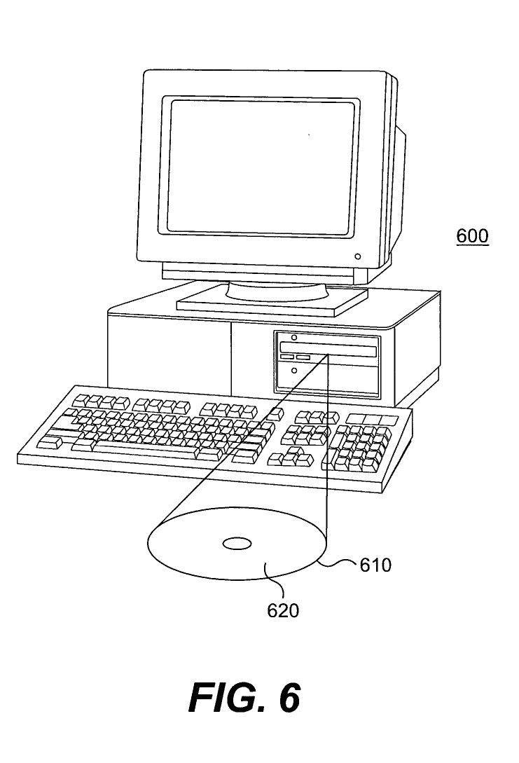

FIG. 6 shows a computer system 600 usable for developing a UNIX® operating system including autoload stub modules. To implement autoload stub modules, a computer readable medium 610 is provided with appropriate programming 620, including an operating system (O/S). The programming 620 operates on the existing kernel and its associated miscellaneous DLKMs to generate autoload stub modules.

The computer readable medium 600 may be any known medium, including optical discs, magnetic discs, hard discs, and other storage devices known to those of skill in the art. Alternatively, the programming required to implement the autoload stub modules may be provided using a carrier wave over a communications network such as the Internet, for example.

1. A dynamically loadable stub module, associated with a dynamically loadable kernel module (DLKM), comprising:
a base stub module;
means for defining DLKM data structures and wrapper functions;
means for defining load and unload routines;
means for defining metadata structures;
means for allowing dynamic loading by DLKM infrastructures; and
means for generating a dynamically loadable stub module object file.

2. The dynamically loadable stub module of claim 1, wherein the means for defining the DLKM data structures and wrapper functions comprises:
struct mod_type_data;
struct modlink;
struct modwrapper; and
struct mod_operations.

3. The dynamically loadable stub module of claim 1, wherein the means for defining the DLKM data structures and wrapper functions comprises an autoload statement.

4. The dynamically loadable stub module of claim 3, wherein the autoload statement comprises statements class, and one of stub funcname retfunc, ustub funcname retfunc argnword, and wstub funcname retfunc.

5. The dynamically loadable stub module of claim 1, wherein the means for defining load and unload routines comprises:
<module_name>_stub_load ( ); and
<module_name>_stub_unload ( ).

6. The dynamically loadable stub module of claim 1, wherein the means for defining metadata structures comprises module version, type, definition, states, and loadtime.

7. The dynamically loadable stub module of claim 1, wherein the means for defining metadata structures comprises a developer-supplied modmeta file.

8. The dynamically loadable stub module of claim 7, wherein the modmeta file is compiled by a modmeta compiler to produce a stub_modmeta.c file.

9. The dynamically loadable stub module of claim 7, wherein metadata is supplied from the associated DLKM.

10. The dynamically loadable stub module of claim 1, wherein the dynamically loadable stub module is included in a kernel data space.

11. The dynamically loadable stub module of claim 1, wherein the dynamically loadable stub module is capable of being statically linked to a kernel executable.

12. The dynamically loadable stub module of claim 1, wherein the data structures comprise:
struct mod_stub_modinfo; and
struct mod_stubinfo.

13. The dynamically loadable stub module of claim 12, further comprising the stub routines that use the data structures to manipulate stack frames to transfer control from the dynamically loadable stub module to the associated DLKM.

14. The dynamically loadable stub module of claim 1, wherein the means for allowing dynamic loading by DLKM infrastructures comprises an ELF section.

15. The dynamically loadable stub module of claim 1, wherein the associated DLKM is a miscellaneous module.

16. A method for dynamic loading of a stub module, comprising:
modifying a base stub module for an associated DLKM, comprising:
defining DLKM data structures and wrapper functions for the stub module;
defining load and unload routines for the stub module;
defining metadata structures for the stub module;
providing for dynamic loading of the stub module by DLKM infrastructures; and
generating a dynamically loadable stub module object file.

17. The method of claim 16, wherein defining DLKM data structures and wrapper functions comprises defining:
struct mod_type data;
struct modlink;
struct modwrapper; and
struct mod_operations.

18. The method of claim 16, wherein defining DLKM data structures and wrapper functions comprises providing an autoload statement comprising class, and one of stub funcname retfunc, ustub funcname retfunc argnword, and wstub funcname retfunc.

19. The method of claim 16, wherein defining metadata structures comprises providing a developer-supplied modmeta file.

20. The dynamically loadable stub module of claim 19, further comprising compiling the modmeta file to produce a stub_modmeta.c file.

21. A computer-readable medium having computer code to implement autoload stub modules, the code when executed comprising the following steps:
defining DLKM data structures and wrapper functions for the stub module;
defining load and unload routines for the stub module;
defining metadata structures for the stub module;
providing for dynamic loading of the stub module by DLKM infrastructures; and
generating a dynamically loadable stub module object file.
